(19) United States
(12) Patent Application Publication
(10) Pub. No.: US 2025/0212919 A1
(43) Pub. Date: Jul. 3, 2025

(54) METHOD FOR MANUFACTURING TOFU LOW-SUGAR RICE CONTAINING INDIGESTIBLE MALTODEXTRIN

(71) Applicant: BokManSa Co, Ltd., Hadong-gun (KR)

(72) Inventors: Eun Woo CHO, Hadong-gun (KR); Han A JUNG, Gwangyang-si (KR); Yeon Sung KIM, Gwangyang-si (KR)

(73) Assignee: BokManSa Co, Ltd., Hadong-gun (KR)

(21) Appl. No.: 18/782,028

(22) Filed: Jul. 24, 2024

(30) Foreign Application Priority Data
Dec. 28, 2023 (KR) 10-2023-0195506

(51) Int. Cl. A23L 7/196; A23L 5/10; A23L 11/45; A23L 29/30

(52) U.S. Cl. CPC A23L 7/1965; A23L 5/10; A23L 11/45; A23L 29/35

(57) ABSTRACT

A method for manufacturing low-sugar tofu rice containing indigestible maltodextrin, includes: a first step of preparing grains by pretreating them; a second step of preparing rice cooking water containing mulberry leaves, Solomon's seal, and bitter melon; and a third step of mixing and cooking the pretreated grains, the rice cooking water, indigestible maltodextrin, tofu, soaked white rice, protein powder, konjac, and coconut oil to manufacture low-sugar rice. In addition, the pretreatment of the first stage includes: a step 1-1 of washing the grains and soaking them for 30 to 60 minutes; a step 1-2 of adding 5 to 7 parts by weight of water to 10 parts by weight of the soaked grains and heating them for 10 to 15 minutes; and a step 1-3 of washing the heated grains with water to remove starch.

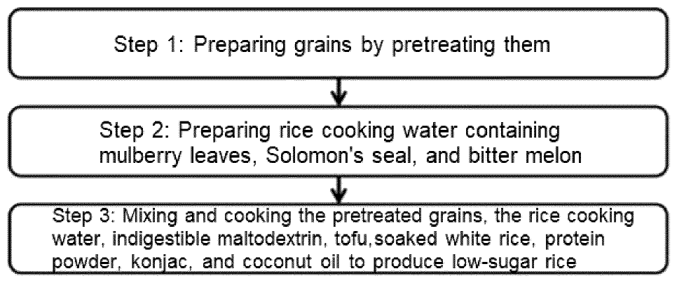

### CROSS-REFERENCE TO PRIOR APPLICATION

This application claims priority to Korean Patent Application No. 10-2023-0195506 (filed on Dec. 28, 2023), which is hereby incorporated by reference in its entirety.

### BACKGROUND

The present invention relates to a method for manufacturing tofu low-sugar rice containing indigestible maltodextrin, which provides a feeling of fullness with high protein and high dietary fiber derived from indigestible maltodextrin, tofu, and protein, and offers excellent taste when cooked with rice cooking water containing mulberry leaves, Solomon's seal, and bitter melon.

The increase in the incidence of diabetes is a worldwide trend due to westernized eating habits and aging population caused by economic development. To prevent diabetes, the “National Diabetes Management Strategy” identifies poor eating habits and abnormal glucose tolerance as risk factors, recommending improved eating habits and exercise therapy. Additionally, it is known that excessive blood sugar levels after meals increase the prevalence of diabetes by causing insulin hypersecretion and decreased insulin sensitivity, making postprandial blood sugar control particularly important.

Indigestible maltodextrin has been proven to suppress postprandial blood sugar rise, promote bowel movements, and improve blood neutral lipids. It reduces excessive insulin secretion by slowing the absorption rate of sugar into the bloodstream. Additionally, indigestible maltodextrin intake inhibits the diffusion of nutrients like glucose and slows the digestion and absorption of food as it moves to the lower part of the small intestine, ultimately slowing glucose absorption and suppressing excessive rises in blood sugar levels.

This indigestible maltodextrin is a health-functional substance obtained by enzymatically decomposing besodextrin, which is produced by heating corn starch with alpha-amylase and amyloglucosidase, followed by refining and fractionating the remaining indigestible components. It has a dietary fiber content of more than 80% of the indicated amount and is listed as a functional ingredient in the Health Functional Food Code.

### PRIOR ART DOCUMENTS

### Patent Documents

(Patent Document 1) Korean Patent Publication No. 10-2014-0130370

### SUMMARY

To address the above problems, the present invention provides a method for manufacturing tofu low-sugar rice containing indigestible maltodextrin, tofu, and protein. This method offers a feeling of satiety due to high protein and high dietary fiber content, and provides excellent taste when cooked with rice cooking water containing mulberry leaves, Solomon's seal, and bitter melon.

To achieve the above-described purpose, a method for manufacturing tofu low-sugar rice containing indigestible maltodextrin according to the present invention includes a first step of preparing grains by pretreating them; a second step of preparing rice cooking water containing mulberry leaves, Solomon's seal and bitter melon; and a third step of manufacturing low-sugar rice by mixing and cooking the pretreated grains with rice cooking water, indigestible maltodextrin, tofu, soaked white rice, protein powder, konjac, and coconut oil.

In addition, the pretreatment of the first step includes: a step 1-1 of washing the grains and soaking them for 30 to 60 minutes; a step 1-2 of adding 5 to 7 parts by weight of water to 10 parts by weight of the soaked grains and heating them for 10 to 15 minutes; and a step 1-3 of washing the heated grains with water to remove starch.

Furthermore, the rice cooking water of the second step is prepared by mixing 0.22 to 0.225 parts by weight of mulberry leaves, 0.22 to 0.225 parts by weight of Solomon's seal, and 0.05 to 0.1 parts by weight of bitter melon with 200 parts by weight of water, and extracting at 100° C. for 25 to 30 minutes.

In addition, the low-sugar rice of the third step is manufactured by mixing and cooking 30 parts by weight of the pretreated grains, 35 to 40 parts by weight of the rice cooking water, 1 to 2 parts by weight of indigestible maltodextrin, 8 to 10 parts by weight of tofu, 30 to 40 parts by weight of soaked white rice, 1 to 2 parts by weight of protein powder, 5 to 10 parts by weight of konjac, and 0.1 to 0.3 parts by weight of coconut oil.

To address the above problem, the present invention proposes a method for manufacturing low-sugar tofu rice containing indigestible maltodextrin. This method enhances satiety due to the high content of protein and dietary fiber from the inclusion of indigestible maltodextrin, tofu, and other proteins. Additionally, the method improves the taste by cooking the rice with water infused with mulberry leaves, Solomon's seal, and bitter melon.

In addition, this method helps reduce the risk of developing adult diseases, such as diabetes, by enabling continuous control of eating habits through a daily diet, without the need for separate health functional foods.

However, the effects of the invention are not limited to those mentioned above. Other benefits will become apparent to those skilled in the art from the following description.

### BRIEF DESCRIPTION OF THE DRAWING

The FIGURE is a flow chart showing a method for manufacturing tofu low-sugar rice containing indigestible maltodextrin.

### DESCRIPTION OF SIGNS

S1: Step 1 of preparing grains by pretreating them

S2: Step 2 of preparing rice cooking water containing mulberry leaves, Solomon's seal, and bitter melon

S3: Step 3 of mixing the pretreated grains with the rice cooking water, indigestible maltodextrin, tofu, soaked white rice, protein powder, konjac, and coconut oil, and cooking them to produce low-sugar rice

### DETAILED DESCRIPTION

The specific details of the present invention, including the problem to be solved, the proposed solution, and the beneficial effects, are provided in the embodiments and drawings described below. The advantages and features of the present invention, along with the methods for achieving them, will become clear through detailed reference to the following embodiments and accompanying drawings.

Hereinafter, a method for manufacturing low-sugar tofu rice containing indigestible maltodextrin, as presented above, will be described in detail with reference to the accompanying drawings.

### <A Method for Manufacturing Tofu Low-Sugar Rice Containing Indigestible Maltodextrin>

A method for manufacturing low-sugar tofu rice containing indigestible maltodextrin according to the present invention comprises a first step (S1) of preparing grains by pretreating them, a second step (S2) of preparing rice cooking water containing mulberry leaves, Solomon's seal, and bitter melon, and a third step (S3) of mixing and cooking the pretreated grains, the rice cooking water, indigestible maltodextrin, tofu, soaked white rice, protein powder, konjac, and coconut oil to manufacture low-sugar rice.

The first step (S1) is a process for preparing grains by pretreating them. Specifically, the pretreatment comprises: step 1-1 of washing grains and soaking them for 30 to 60 minutes; step 1-2 of adding 5 to 7 parts by weight of water to 10 parts by weight of the soaked grains and heating them for 10 to 15 minutes; and step 1-3 of washing the heated grains with water to remove starch.

The above step 1-1 is to wash the grains and soak them for 30 to 60 minutes. Specifically, it is preferable to soak them for 30 minutes in the summer and 60 minutes in the winter.

The above step 1-2 is to add 5 to 7 parts by weight of water to 10 parts by weight of the soaked grains and heating them for 10 to 15 minutes. Here, if less than 5 parts by weight of water is added, there is insufficient water to adequately dissolve the starch in the grains. Conversely, if more than 7 parts by weight of water is added, it only increases the heating time, reducing work efficiency. Additionally, if the heating time is less than 10 minutes, it is too short to sufficiently dissolve the starch. However, if the heating time exceeds 15 minutes, the grains are already sufficiently heated, resulting in unnecessary time increase and reduced efficiency.

The above step 1-3 involves washing the heated grains with water to remove starch. Specifically, the heated grains are placed in a strainer and washed three times with water to remove the starch. This process reduces the carbohydrates in the grains and simultaneously lowers the calories, allowing for the production of low-sugar rice.

The second step (S2) is a process for producing rice cooking water containing mulberry leaves, Solomon's seal, and bitter melon. Specifically, 0.22 to 0.225 parts by weight of mulberry leaves, 0.22 to 0.225 parts by weight of Solomon's seal, and 0.05 to 0.1 parts by weight of bitter melon are mixed with 200 parts by weight of water, and extracted at 100° C. for 25 to 30 minutes to produce rice cooking water.

According to Donguibogam, mulberry leaves are effective in treating and preventing diseases such as stroke, obesity, arthritis, edema, diarrhea, and asthma by eliminating waste products from the body and blood vessels. They are also known to lower blood sugar and blood pressure, promote digestive function, enhance urination, and relieve thirst.

Solomon's seal primarily affects blood pressure, heart health, and blood sugar levels. It is beneficial for improving weak constitution, pulmonary tuberculosis, dry cough, and thirst. Additionally, it strengthens the heart, making it helpful for individuals with heart conditions such as heart failure and angina pectoris.

Bitter melon is an annual vine of the Cucurbitaceae family, and its fruit is known to have greater medicinal value than edible value. This is because the caratin contained in bitter melon has no side effects, removes LDL cholesterol from liver cells, enhances insulin secretion, and helps manage diabetes by continuously normalizing the hormonal system. Additionally, the polyphenol component in bitter melon is a powerful anticancer agent.

Here, if less than 0.22 parts by weight of mulberry leaves are mixed with 200 parts by weight of water, the effective ingredients of the mulberry leaves are insufficient. Conversely, if more than 0.225 parts by weight are mixed, the flavor of the mulberry leaves becomes too strong and may spoil the taste of the produced rice.

In addition, if less than 0.22 parts by weight of Solomon's seal is mixed with 100 parts by weight of water, the effective ingredient of Solomon's seal is insufficient. Conversely, if more than 0.225 parts by weight is mixed, the color and flavor of the produced rice may be adversely affected.

Furthermore, if less than 0.05 parts by weight of bitter melon is mixed with 100 parts by weight of water, the effective ingredients of the bitter melon are insufficient. Conversely, if more than 0.1 parts by weight is mixed, the bitter and astringent taste of the bitter melon may impair the overall flavor of the rice being manufactured.

In addition, if the extraction temperature is lower than 100° C., the effective ingredients may not be sufficiently contained in the rice cooking water. Conversely, if the temperature is higher than 100° C., the bitter taste of the produced rice cooking water may become excessive.

Besides, if the extraction time is shorter than 25 minutes, the effective ingredients are not sufficiently extracted into the rice cooking water, and if it exceeds 30 minutes, the color of the produced rice cooking water becomes dark, which causes a problem of changing the color of the low-sugar rice produced as described below.

Step 3 (S3) is a process for manufacturing low-sugar rice by mixing and cooking the pretreated grains, rice cooking water, indigestible maltodextrin, tofu, soaked white rice, protein powder, konjac, and coconut oil. Specifically, for 30 parts by weight of the pretreated grains, 35 to 40 parts by weight of the rice cooking water, 1 to 2 parts by weight of indigestible maltodextrin, 8 to 10 parts by weight of tofu, 30 to 40 parts by weight of soaked white rice, 1 to 2 parts by weight of protein powder, 5 to 10 parts by weight of konjac, and 0.1 to 0.3 parts by weight of coconut oil are mixed and cooked to produce low-sugar rice.

If the above rice cooking water is mixed in an amount of less than 35 parts by weight for 30 parts by weight of the pretreated grains, the rice may be undercooked or hard, thereby damaging the texture. Conversely, if it is mixed in an amount of more than 40 parts by weight, the resulting low-sugar rice may have excessive moisture.

The above indigestible maltodextrin is a non-viscous, water-soluble dietary fiber known to delay sugar absorption in the body and suppress postprandial blood sugar increases. Various human experiments have proven its effectiveness in suppressing blood sugar spikes, reducing neutral fat concentration, and improving bowel movement. Additionally, it has been reported that consuming dietary fiber with a high proportion of indigestible maltodextrin increases satiety, reduces hunger, aids in weight loss, lowers blood sugar levels, and reduces insulin resistance, making it a promising functional food material for diabetes prevention and dietary therapy. Here, if indigestible maltodextrin is mixed in an amount less than 1 part by weight relative to 30 parts by weight of the pretreated grains, its functionality cannot be expected. Conversely, if it is mixed in an amount exceeding 2 parts by weight, it may negatively affect quality, such as the color of the rice.

The above tofu is a vegetable high-protein food made by grinding soaked soybeans, filtering out the residue, heating the soybean water, adding a coagulant, and solidifying it. Tofu has a soft and mild taste, good digestibility, and is rich in protein necessary for growth, development, and metabolism. It also contains a lot of calcium and vegetable fat, making it nutritious and low in calories, and is widely used as a diet food. If the tofu is mixed in an amount less than 8 parts by weight relative to 30 parts by weight of the pretreated grains, the vegetable protein content is insufficient, and the texture is reduced. Conversely, if more than 10 parts by weight is mixed, the manufactured low-sugar rice may lack stickiness.

If the above-mentioned white rice is mixed in an amount less than 30 parts by weight relative to 30 parts by weight of the pretreated grains, the overall flavor may be reduced due to the relatively excessive amount of grains. Conversely, if it is mixed in an amount exceeding 40 parts by weight, the rice may be undercooked and have a hard texture.

The above protein powder is added to further increase the protein content of the low-sugar rice being manufactured. If it is mixed in an amount less than 1 part by weight relative to 30 parts by weight of the pretreated grains, its functionality cannot be expected. Conversely, if it is mixed in an amount exceeding 2 parts by weight, the flavor of the low-sugar rice being manufactured may be reduced.

The above konjac is a processed food made from the corm of the konjac plant and is used as a diet food because it is low in calories and provides a feeling of fullness. It is preferable to use konjac with a starch content of less than 5 wt %, as konjac contains moisture. If konjac is mixed in an amount less than 5 parts by weight relative to 30 parts by weight of the pretreated grains, it may reduce the feeling of fullness when consuming the manufactured low-sugar rice and make it difficult to achieve a chewy texture. Conversely, if it is mixed in an amount exceeding 10 parts by weight, the manufactured low-sugar rice may lack stickiness.

The above coconut oil has a high content of medium-chain fatty acids, which help prevent dementia. Medium-chain fatty acids are not accumulated in the body but are converted into ketone bodies that provide nutrition to brain cells and a feeling of fullness. If coconut oil is mixed in an amount less than 0.1 part by weight relative to 30 parts by weight of the pretreated grains, it may reduce the rich taste, flavor, and gloss of the manufactured low-sugar rice. Conversely, if it is mixed in an amount exceeding 0.3 parts by weight, the flavor of coconut oil can overpower and reduce the overall flavor.

Hereinafter, the experimental results for a method for manufacturing tofu low-sugar rice containing indigestible maltodextrin according to the present invention will be described in detail.

### 1. Sensory Evaluation of Low-Sugar Rice According to Pretreatment Heating of Grains

To compare the quality characteristics of the manufactured low-sugar rice, low-sugar rice was produced according to the above manufacturing method with variations in the Pretreatment heating of the grains, and graduate students from the Department of Food Engineering, recognized as suitable inspectors, were appropriately trained for the purpose of this experiment before participating in the sensory evaluation. The sensory evaluation assessed appearance, taste, stickiness, and overall flavor using a 9-point Likert scale method, where 9 points indicated “very good” and 1 point indicated “very bad.”

### Comparative Example 1

Comparative example 1: Grains are washed and soaked for 45 minutes. Next, 0.225 parts by weight of mulberry leaves, 0.225 parts by weight of Solomon's seal, and 0.05 parts by weight of bitter melon are mixed with 200 parts by weight of water and extracted at 100° C. for 30 minutes to prepare rice cooking water. Following this, 40 parts by weight of the rice cooking water, 2 parts by weight of indigestible maltodextrin, 10 parts by weight of tofu, 40 parts by weight of soaked white rice, 2 parts by weight of protein powder, 10 parts by weight of konjac, and 0.3 parts by weight of coconut oil are mixed with 30 parts by weight of the grains from which the starch has been removed, and cooked to produce low-sugar rice.

### Embodiment 1

Embodiment 1: Grains are washed and soaked for 45 minutes, then 7 parts by weight of water are added to 10 parts by weight of the soaked grains and heated for 5 minutes. The heated grains are then washed with water to remove starch. Next, 0.225 parts by weight of mulberry leaves, 0.225 parts by weight of Solomon's seal, and 0.05 parts by weight of bitter melon are mixed with 200 parts by weight of water and extracted at 100° C. for 30 minutes to prepare rice cooking water. Following this, 40 parts by weight of the rice cooking water, 2 parts by weight of indigestible maltodextrin, 10 parts by weight of tofu, 40 parts by weight of soaked white rice, 2 parts by weight of protein powder, 10 parts by weight of konjac, and 0.3 parts by weight of coconut oil are mixed with 30 parts by weight of the grains from which the starch has been removed and cooked to produce low-sugar rice.

### Embodiment 2

Embodiment 2: Grains are washed and soaked for 45 minutes, then 7 parts by weight of water are added to 10 parts by weight of the soaked grains and heated for 10 minutes. The heated grains are then washed with water to remove starch. Next, 0.225 parts by weight of mulberry leaves, 0.225 parts by weight of Solomon's seal, and 0.05 parts by weight of bitter melon are mixed with 200 parts by weight of water and extracted at 100° C. for 30 minutes to prepare rice cooking water. Following this, 40 parts by weight of the rice cooking water, 2 parts by weight of indigestible maltodextrin, 10 parts by weight of tofu, 40 parts by weight of soaked white rice, 2 parts by weight of protein powder, 10 parts by weight of konjac, and 0.3 parts by weight of coconut oil are mixed with 30 parts by weight of the grains from which the starch has been removed, and cooked to produce low-sugar rice.

### Embodiment 3

Embodiment 3: Grains are washed and soaked for 45 minutes, then 7 parts by weight of water are added to 10 parts by weight of the soaked grains and heated for 15 minutes. The heated grains are then washed with water to remove starch. Next, 0.225 parts by weight of mulberry leaves, 0.225 parts by weight of Solomon's seal, and 0.05 parts by weight of bitter melon are mixed with 200 parts by weight of water and extracted at 100° C. for 30 minutes to prepare rice cooking water. Following this, 40 parts by weight of the rice cooking water, 2 parts by weight of indigestible maltodextrin, 10 parts by weight of tofu, 40 parts by weight of soaked white rice, 2 parts by weight of protein powder, 10 parts by weight of konjac, and 0.3 parts by weight of coconut oil are mixed with 30 parts by weight of the grains from which the starch has been removed, and cooked to produce low-sugar rice.

### Embodiment 4

Embodiment 4: Grains are washed and soaked for 45 minutes, then 7 parts by weight of water are added to 10 parts by weight of the soaked grains and heated for 20 minutes. The heated grains are then washed with water to remove starch. Next, 0.225 parts by weight of mulberry leaves, 0.225 parts by weight of Solomon's seal, and 0.05 parts by weight of bitter melon are mixed with 200 parts by weight of water and extracted at 100° C. for 30 minutes to prepare rice cooking water. Following this, 40 parts by weight of the rice cooking water, 2 parts by weight of indigestible maltodextrin, 10 parts by weight of tofu, 40 parts by weight of soaked white rice, 2 parts by weight of protein powder, 10 parts by weight of konjac, and 0.3 parts by weight of coconut oil are mixed with 30 parts by weight of the grains from which the starch has been removed, and cooked to produce low-sugar rice.

TABLE 1

| | Pretreatment | | | | |
|---|---|---|---|---|---|
| | heating | | | | Overall |
| | (min) | Appearance | Taste | Stickiness | flavor |
| Comparative | — | 7.4 | 7.1 | 7.8 | 7.4 |
| example 1 | | | | | |
| Embodiment 1 | 5 | 7.8 | 7.6 | 7.9 | 7.7 |
| Embodiment 2 | 10 | 8.2 | 8.0 | 8.3 | 8.1 |
| Embodiment 3 | 15 | 8.6 | 8.7 | 8.6 | 8.6 |
| Embodiment 4 | 20 | 7.8 | 7.7 | 7.5 | 7.6 |

As shown in Table 1 above, when the heating time of the soaked grains was less than 10 minutes, the starch in the grains was not sufficiently dissolved, reducing the stickiness and overall flavor of the manufactured low-sugar rice. When the heating time exceeded 15 minutes, the starch was excessively released, which also lowered the taste and reduced the overall flavor.

Therefore, as shown in Embodiments 2 and 3, the heating time of the soaked grains is preferably 10 to 15 minutes, and most preferably, as shown in Embodiment 3, it is 15 minutes.

### 2. Sensory Evaluation of Low-Sugar Rice According to Extraction Time of Rice Cooking Water

To compare the quality characteristics of manufactured low-sugar rice, low-sugar rice was manufactured according to the above manufacturing method by varying the extraction time of rice cooking water, and graduate students from the Department of Food Engineering, recognized as suitable inspectors, were appropriately trained for the purpose of this experiment before participating in the sensory evaluation. The sensory evaluation was performed using a 9-point Likert scale method, where 9 points indicated “very good” and 1 point indicated “very bad.” The evaluation assessed appearance, taste, stickiness, and overall flavor.

### Comparative Example 2

Comparative example 2: Grains are washed and soaked for 45 minutes, then 7 parts by weight of water are added to 10 parts by weight of the soaked grains and heated for 15 minutes. The heated grains are then washed with water to remove starch. Next, 40 parts by weight of water, 2 parts by weight of indigestible maltodextrin, 10 parts by weight of tofu, 40 parts by weight of soaked white rice, 2 parts by weight of protein powder, 10 parts by weight of konjac, and 0.3 parts by weight of coconut oil are mixed with 30 parts by weight of the grains from which the starch has been removed, and cooked to produce low-sugar rice.

### Embodiment 5

Embodiment 5: Grains are washed and soaked for 45 minutes, then 7 parts by weight of water are added to 10 parts by weight of the soaked grains and heated for 15 minutes. The heated grains are then washed with water to remove starch. Next, 0.225 parts by weight of mulberry leaves, 0.225 parts by weight of Solomon's seal, and 0.05 parts by weight of bitter melon are mixed with 200 parts by weight of water and extracted at 100° C. for 20 minutes to prepare rice cooking water. Following this, 40 parts by weight of the rice cooking water, 2 parts by weight of indigestible maltodextrin, 10 parts by weight of tofu, 40 parts by weight of soaked white rice, 2 parts by weight of protein powder, 10 parts by weight of konjac, and 0.3 parts by weight of coconut oil are mixed with 30 parts by weight of the grains from which the starch has been removed, and cooked to produce low-sugar rice.

### Embodiment 6

Embodiment 6: Grains are washed and soaked for 45 minutes, then 7 parts by weight of water are added to 10 parts by weight of the soaked grains and heated for 15 minutes. The heated grains are then washed with water to remove starch. Next, 0.225 parts by weight of mulberry leaves, 0.225 parts by weight of Solomon's seal, and 0.05 parts by weight of bitter melon are mixed with 200 parts by weight of water and extracted at 100° C. for 25 minutes to prepare rice cooking water. Following this, 40 parts by weight of the rice cooking water, 2 parts by weight of indigestible maltodextrin, 10 parts by weight of tofu, 40 parts by weight of soaked white rice, 2 parts by weight of protein powder, 10 parts by weight of konjac, and 0.3 parts by weight of coconut oil are mixed with 30 parts by weight of the grains from which the starch has been removed, and cooked to produce low-sugar rice.

### Embodiment 7

Embodiment 7: Grains are washed and soaked for 45 minutes, then 7 parts by weight of water are added to 10 parts by weight of the soaked grains and heated for 15 minutes. The heated grains are then washed with water to remove starch. Next, 0.225 parts by weight of mulberry leaves, 0.225 parts by weight of Solomon's seal, and 0.05 parts by weight of bitter melon are mixed with 200 parts by weight of water and extracted at 100° C. for 30 minutes to prepare rice cooking water. Following this, 40 parts by weight of the rice cooking water, 2 parts by weight of indigestible maltodextrin, 10 parts by weight of tofu, 40 parts by weight of soaked white rice, 2 parts by weight of protein powder, 10 parts by weight of konjac, and 0.3 parts by weight of coconut oil are mixed with 30 parts by weight of the grains from which the starch has been removed, and cooked to produce low-sugar rice.

### Embodiment 8

Embodiment 8: Grains are washed and soaked for 45 minutes, then 7 parts by weight of water are added to 10 parts by weight of the soaked grains and heated for 15 minutes. The heated grains are then washed with water to remove starch. Next, 0.225 parts by weight of mulberry leaves, 0.225 parts by weight of Solomon's seal, and 0.05 parts by weight of bitter melon are mixed with 200 parts by weight of water and extracted at 100° C. for 35 minutes to prepare rice cooking water. Following this, 40 parts by weight of the rice cooking water, 2 parts by weight of indigestible maltodextrin, 10 parts by weight of tofu, 40 parts by weight of soaked white rice, 2 parts by weight of protein powder, 10 parts by weight of konjac, and 0.3 parts by weight of coconut oil are mixed with 30 parts by weight of the grains from which the starch has been removed, and cooked to produce low-sugar rice.

TABLE 2

| | Extraction | | | | |
|---|---|---|---|---|---|
| | time | | | | Overall |
| | (min) | Appearance | Taste | Stickiness | flavor |
| Comparative | — | 7.6 | 7.3 | 7.4 | 7.4 |
| example 2 | | | | | |
| Embodiment | 20 | 7.8 | 8.1 | 7.8 | 7.9 |
| 5 | | | | | |
| Embodiment | 25 | 8.2 | 8.5 | 8.1 | 8.2 |
| 6 | | | | | |
| Embodiment | 30 | 8.6 | 8.7 | 8.6 | 8.6 |
| 7 | | | | | |
| Embodiment | 35 | 7.7 | 7.5 | 8.2 | 7.8 |
| 8 | | | | | |

As shown in Table 2 above, when the extraction time of the rice cooking water was less than 25 minutes, the savory flavor was less pronounced, resulting in a decrease in the overall flavor. Conversely, when the extraction time exceeded 30 minutes, the color of the manufactured low-sugar rice became dark, also resulting in a decrease in the overall flavor.

Therefore, it is preferable to set the extraction time of the rice cooking water to 25 to 30 minutes, as in Embodiments 6 to 7, and it is most preferable to set it to 30 minutes, as in Embodiment 7.

### 3. Sensory Evaluation of Low-Sugar Rice According to the Amount of Rice Cooking Water Mixed

To compare the quality characteristics of manufactured low-sugar rice, low-sugar rice is manufactured according to the above manufacturing method by varying the amount of rice cooking water, and graduate students from the Department of Food Engineering, recognized as suitable inspectors, were appropriately trained for the purpose of this experiment before participating in the sensory evaluation. The sensory evaluation assessed appearance, taste, stickiness, and overall flavor using a 9-point Likert scale method, where 9 points indicated “very good” and 1 point indicated “very bad.”

### Comparative Example 2

Comparative example 2: Grains are washed and soaked for 45 minutes, then 7 parts by weight of water are added to 10 parts by weight of the soaked grains and heated for 15 minutes. The heated grains are then washed with water to remove starch. Next, 40 parts by weight of water, 2 parts by weight of indigestible maltodextrin, 10 parts by weight of tofu, 40 parts by weight of soaked white rice, 2 parts by weight of protein powder, 10 parts by weight of konjac, and 0.3 parts by weight of coconut oil are mixed with 30 parts by weight of the grains from which the starch has been removed, and cooked to produce low-sugar rice.

### Embodiment 9

Embodiment 9: Grains are washed and soaked for 45 minutes, then 7 parts by weight of water are added to 10 parts by weight of the soaked grains and heated for 15 minutes. The heated grains are then washed with water to remove starch. Next, 0.225 parts by weight of mulberry leaves, 0.225 parts by weight of Solomon's seal, and 0.05 parts by weight of bitter melon are mixed with 200 parts by weight of water and extracted at 100° C. for 30 minutes to prepare rice cooking water. Following this, 30 parts by weight of the rice cooking water, 2 parts by weight of indigestible maltodextrin, 10 parts by weight of tofu, 40 parts by weight of soaked white rice, 2 parts by weight of protein powder, 10 parts by weight of konjac, and 0.3 parts by weight of coconut oil are mixed with 30 parts by weight of the grains from which the starch has been removed, and cooked to produce low-sugar rice.

### Embodiment 10

Embodiment 10: Grains are washed and soaked for 45 minutes, then 7 parts by weight of water are added to 10 parts by weight of the soaked grains and heated for 15 minutes. The heated grains are then washed with water to remove starch. Next, 0.225 parts by weight of mulberry leaves, 0.225 parts by weight of Solomon's seal, and 0.05 parts by weight of bitter melon are mixed with 200 parts by weight of water and extracted at 100° C. for 30 minutes to prepare rice cooking water. Following this, 35 parts by weight of the rice cooking water, 2 parts by weight of indigestible maltodextrin, 10 parts by weight of tofu, 40 parts by weight of soaked white rice, 2 parts by weight of protein powder, 10 parts by weight of konjac, and 0.3 parts by weight of coconut oil are mixed with 30 parts by weight of the grains from which the starch has been removed, and cooked to produce low-sugar rice.

### Embodiment 11

Embodiment 11: Grains are washed and soaked for 45 minutes, then 7 parts by weight of water are added to 10 parts by weight of the soaked grains and heated for 15 minutes. The heated grains are then washed with water to remove starch. Next, 0.225 parts by weight of mulberry leaves, 0.225 parts by weight of Solomon's seal, and 0.05 parts by weight of bitter melon are mixed with 200 parts by weight of water and extracted at 100° C. for 30 minutes to prepare rice cooking water. Following this, 40 parts by weight of the rice cooking water, 2 parts by weight of indigestible maltodextrin, 10 parts by weight of tofu, 40 parts by weight of soaked white rice, 2 parts by weight of protein powder, 10 parts by weight of konjac, and 0.3 parts by weight of coconut oil are mixed with 30 parts by weight of the grains from which the starch has been removed, and cooked to produce low-sugar rice.

### Embodiment 12

Embodiment 12: Grains are washed and soaked for 45 minutes, then 7 parts by weight of water are added to 10 parts by weight of the soaked grains and heated for 15 minutes. The heated grains are then washed with water to remove starch. Next, 0.225 parts by weight of mulberry leaves, 0.225 parts by weight of Solomon's seal, and 0.05 parts by weight of bitter melon are mixed with 200 parts by weight of water and extracted at 100° C. for 30 minutes to prepare rice cooking water. Following this, 45 parts by weight of the rice cooking water, 2 parts by weight of indigestible maltodextrin, 10 parts by weight of tofu, 40 parts by weight of soaked white rice, 2 parts by weight of protein powder, 10 parts by weight of konjac, and 0.3 parts by weight of coconut oil are mixed with 30 parts by weight of the grains from which the starch has been removed, and cooked to produce low-sugar rice.

TABLE 3

| | Rice cooking | | | | Overall |
|---|---|---|---|---|---|
| | water mixed | Appearance | Taste | Stickiness | flavor |
| Comparative | 40 parts by | 7.6 | 7.3 | 7.4 | 7.4 |
| example 2 | weight of water | | | | |
| Embodiment | 30 parts by | 7.7 | 8.0 | 7.6 | 7.7 |
| 9 | weight of rice | | | | |
| | cooking water | | | | |
| Embodiment | 35 parts by | 8.1 | 8.5 | 8.0 | 8.2 |
| 10 | weight of rice | | | | |
| | cooking water | | | | |
| Embodiment | 40 parts by | 8.6 | 8.7 | 8.6 | 8.6 |
| 11 | weight of rice | | | | |
| | cooking water | | | | |
| Embodiment | 45 parts by | 7.6 | 7.9 | 7.5 | 7.6 |
| 12 | weight of rice | | | | |
| | cooking water | | | | |

As shown in Table 3 above, when the mixing amount of the rice cooking water is less than 35 parts by weight, the taste and stickiness of the manufactured low-sugar rice are reduced, thereby diminishing the overall flavor. Conversely, when it exceeds 40 parts by weight, the moisture content of the manufactured low-sugar rice becomes excessive, and the taste of the rice cooking water becomes too strong, also reducing the overall flavor.

Therefore, it is preferable to set the mixing amount of the rice cooking water to 35 to 40 parts by weight as in Embodiments 10 to 11, and it is most preferable to set it to 40 parts by weight as in Embodiment 11.

### 4. Sensory Evaluation of Low-Sugar Rice According to the Amount of Tofu Mixed

To compare the quality characteristics of manufactured low-sugar rice, low-sugar rice was manufactured according to the manufacturing method above by varying the amount of tofu mixed, and graduate students from the Department of Food Engineering, recognized as suitable inspectors, were appropriately trained for the purpose of this experiment before participating in the sensory evaluation. The sensory evaluation assessed appearance, taste, stickiness, and overall flavor using a 9-point Likert scale method, where 9 points indicated “very good” and 1 point indicated “very bad.”

### Comparative Example 3

Comparative example 3: Grains are washed and soaked for 45 minutes, then 7 parts by weight of water are added to 10 parts by weight of the soaked grains and heated for 15 minutes. The heated grains are then washed with water to remove starch. Next, 0.225 parts by weight of mulberry leaves, 0.225 parts by weight of Solomon's seal, and 0.05 parts by weight of bitter melon are mixed with 200 parts by weight of water and extracted at 100° C. for 30 minutes to prepare rice cooking water. Following this, 40 parts by weight of the rice cooking water, 2 parts by weight of indigestible maltodextrin, 40 parts by weight of soaked white rice, 2 parts by weight of protein powder, 10 parts by weight of konjac, and 0.3 parts by weight of coconut oil are mixed with 30 parts by weight of the grains from which the starch has been removed, and cooked to produce low-sugar rice.

### Embodiment 13

Embodiment 13: Grains are washed and soaked for 45 minutes, then 7 parts by weight of water are added to 10 parts by weight of the soaked grains and heated for 15 minutes. The heated grains are then washed with water to remove starch. Next, 0.225 parts by weight of mulberry leaves, 0.225 parts by weight of Solomon's seal, and 0.05 parts by weight of bitter melon are mixed with 200 parts by weight of water and extracted at 100° C. for 30 minutes to prepare rice cooking water. Following this, 40 parts by weight of the rice cooking water, 2 parts by weight of indigestible maltodextrin, 6 parts by weight of tofu, 40 parts by weight of soaked white rice, 2 parts by weight of protein powder, 10 parts by weight of konjac, and 0.3 parts by weight of coconut oil are mixed with 30 parts by weight of the grains from which the starch has been removed, and cooked to produce low-sugar rice.

### Embodiment 14

Embodiment 14: Grains are washed and soaked for 45 minutes, then 7 parts by weight of water are added to 10 parts by weight of the soaked grains and heated for 15 minutes. The heated grains are then washed with water to remove starch. Next, 0.225 parts by weight of mulberry leaves, 0.225 parts by weight of Solomon's seal, and 0.05 parts by weight of bitter melon are mixed with 200 parts by weight of water and extracted at 100° C. for 30 minutes to prepare rice cooking water. Following this, 40 parts by weight of the rice cooking water, 2 parts by weight of indigestible maltodextrin, 8 parts by weight of tofu, 40 parts by weight of soaked white rice, 2 parts by weight of protein powder, 10 parts by weight of konjac, and 0.3 parts by weight of coconut oil are mixed with 30 parts by weight of the grains from which the starch has been removed, and cooked to produce low-sugar rice.

### Embodiment 15

Embodiment 15: Grains are washed and soaked for 45 minutes, then 7 parts by weight of water are added to 10 parts by weight of the soaked grains and heated for 15 minutes. The heated grains are then washed with water to remove starch. Next, 0.225 parts by weight of mulberry leaves, 0.225 parts by weight of Solomon's seal, and 0.05 parts by weight of bitter melon are mixed with 200 parts by weight of water and extracted at 100° C. for 30 minutes to prepare rice cooking water. Following this, 40 parts by weight of the rice cooking water, 2 parts by weight of indigestible maltodextrin, 10 parts by weight of tofu, 40 parts by weight of soaked white rice, 2 parts by weight of protein powder, 10 parts by weight of konjac, and 0.3 parts by weight of coconut oil are mixed with 30 parts by weight of the grains from which the starch has been removed, and cooked to produce low-sugar rice.

### Embodiment 16

Embodiment 16: Grains are washed and soaked for 45 minutes, then 7 parts by weight of water are added to 10 parts by weight of the soaked grains and heated for 15 minutes. The heated grains are then washed with water to remove starch. Next, 0.225 parts by weight of mulberry leaves, 0.225 parts by weight of Solomon's seal, and 0.05 parts by weight of bitter melon are mixed with 200 parts by weight of water and extracted at 100° C. for 30 minutes to prepare rice cooking water. Following this, 40 parts by weight of the rice cooking water, 2 parts by weight of indigestible maltodextrin, 12 parts by weight of tofu, 40 parts by weight of soaked white rice, 2 parts by weight of protein powder, 10 parts by weight of konjac, and 0.3 parts by weight of coconut oil are mixed with 30 parts by weight of the grains from which the starch has been removed, and cooked to produce low-sugar rice.

TABLE 4

| | Tofu | | | | Overall |
|---|---|---|---|---|---|
| | mixed | Appearance | Taste | Stickiness | flavor |
| Comparative | — | 7.1 | 7.2 | 7.4 | 7.2 |
| example 3 | | | | | |
| Embodiment | 6 parts | 7.6 | 7.4 | 7.8 | 7.6 |
| 13 | by weight | | | | |
| Embodiment | 8 parts | 8.0 | 8.0 | 8.2 | 8.0 |
| 14 | by weight | | | | |
| Embodiment | 10 parts | 8.6 | 8.7 | 8.6 | 8.6 |
| 15 | by weight | | | | |
| Embodiment | 12 parts | 8.1 | 7.6 | 7.9 | 7.8 |
| 16 | by weight | | | | |

As shown in Table 4 above, when the mixing amount of tofu was less than 8 parts by weight, the softness of the manufactured low-sugar rice was reduced, thereby diminishing the overall flavor. Conversely, when it was mixed in excess of 10 parts by weight, the stickiness of the manufactured low-sugar rice was reduced, also diminishing the overall flavor.

Therefore, it is preferable to use 8 to 10 parts by weight of tofu, as in Embodiments 14 to 15, and it is most preferable to use 10 parts by weight, as in Embodiment 15.

In this way, it will be understood by those skilled in the art that the technical configuration of the present invention described above can be implemented in other specific forms without changing the technical idea or essential features of the present invention.

Therefore, it should be understood that the embodiments described above are illustrative and not restrictive in any respect. The scope of the present invention is defined by the claims set forth below, rather than by the detailed description provided above. Any changes or modifications that fall within the meaning and scope of the claims and their equivalents should be considered as being included within the scope of the present invention.

1. A method for manufacturing tofu low-sugar rice containing indigestible maltodextrin, comprising:
Step 1 of preparing grains by pretreating them;
Step 2 of preparing rice cooking water including mulberry leaves, Solomon's seal, and bitter melon; and
Step 3 of mixing the pretreated grains with the rice cooking water, indigestible maltodextrin, tofu, soaked white rice, protein powder, konjac, and coconut oil, and cooking them to produce low-sugar rice, wherein the pretreatment of Step 1 comprises:
Step 1-1 of washing grains and soaking them for 30 to 60 minutes;
Step 1-2 of adding 5 to 7 weight parts of water to 10 weight parts of the soaked grains and heating them for 10 to 15 minutes; and
Step 1-3 of washing the heated grains with water to remove starch.

2. The method for manufacturing tofu low-sugar rice containing indigestible maltodextrin of claim 1,
wherein the rice cooking water in Step 2 is prepared by mixing 0.22 to 0.225 parts by weight of mulberry leaves, 0.22 to 0.225 parts by weight of Solomon's seal, and 0.05 to 0.1 parts by weight of bitter melon with respect to 200 parts by weight of water, and extracting at a temperature of 100° C. for 25 to 30 minutes.

3. The method for manufacturing tofu low-sugar rice containing indigestible maltodextrin of claim 1,
wherein the low-sugar rice in Step 3 is prepared by mixing and cooking 30 parts by weight of the pretreated grains, 35 to 40 parts by weight of the rice cooking water, 1 to 2 parts by weight of indigestible maltodextrin, 8 to 10 parts by weight of tofu, 30 to 40 parts by weight of soaked white rice, 1 to 2 parts by weight of protein powder, 5 to 10 parts by weight of konjac, and 0.1 to 0.3 parts by weight of coconut oil.
